(19) United States
(12) Patent Application Publication
(10) Pub. No.: US 2009/0057958 A1
(43) Pub. Date: Mar. 5, 2009

(54) COMPRESSION MOULDING FLUFFY CELLULOSIC MATERIAL

(75) Inventors: Gianmario Anghileri, Valmadrera (IT); Lars Goran Nybom, Aby (SE)

Correspondence Address: PEARNE & GORDON LLP, 1801 EAST 9TH STREET, SUITE 1200, CLEVELAND, OH, 44114-3108, US

(73) Assignee: PAPER TECHNOLOGIES S.R.L., MILANO (IT)

(21) Appl. No.: 12/282,795

(22) PCT Filed: Feb. 28, 2007
(86) PCT No.: PCT/EP2007/001724

§ 371 Date: Sep. 12, 2008

(30) Foreign Application Priority Data
Mar. 14, 2006 (IT) MI2006A000447

(51) Int. Cl. B29C 43/00

(52) U.S. Cl. 264/330

(57) ABSTRACT

A method and related apparatus for producing one or several products starting from a cellulose based material have been worked out. A layer of fluffy material (20), to which a glue liquid content (30) is associated, is introduced between opened mould parts (80, 81). The closure of the mould provides an internal cavity (70) substantially conform in shape to the product to be obtained which defines a cavity having a smaller volume than the sum of the volumes of the compressed cellulose material structure (20′) and the volume of the glue liquid content (30). The amount of glue liquid content (30) is chosen so as to completely moisten, during the step of pressing the mould parts (80, 81), the compressed cellulose material structure (20′).

### TECHNICAL FIELD

The present invention relates in general to a method for producing one or several products or objects, a product or an object thus made and an arrangement therefore.

The expression “product” in this text is intended to cover a semi-manufacture structure, which must be treated further in one or more processing steps for forming an object, and the expression “object” in this text is intended to cover a finished or completed object ready for its intended use.

More precisely, the present invention is based upon a method for forming one or more products in a compression moulding procedure or step using one or more female parts and one or more male parts, however, the description is concentrated towards the use of one female part only and a corresponding male part only, and when these parts are in a fully united and interacting position they form a space, mentioned in the succeeding description and claims as a “cavity”, having an inner shape similar to, or corresponding to, the outer and inner shape or design of said product or of said object.

It is especially suggested that the method shall be based upon the following steps:
a) a layer of a fluffy material structure to which is added and/or mixed a glue liquid content is to be introduced between opened mould parts,
b) one or both mould parts are thereafter moved towards each other, to enclose a section of said fluffy material structure and a chosen glue liquid content,
c) said fluffy material structure and said glue liquid content are caused to be displaced towards and into said cavity, in order to compressing said fluffy material structure portion and said glue liquid content by said male part and its related wall sections against inner surfaces of said female part, and its related wall section.
d) both mould parts are thereafter conveyed or moved back towards and into an open initial position.

### BACKGROUND OF THE INVENTION

Methods, arrangements and designs of the above-outlined nature are previously known in the art in a plurality of different embodiments.

As a first example of the state of the art and the technical field, to which the present invention relates, reference might be made to the content of International Patent Application PCT/SE01/02582 (Publication Number WO-A1-02/42070), in which it is shown and disclosed a method and an arrangement for producing one or several products, by means of a compression moulding or die casting procedure, using at least two mould parts arranged to move towards and away from each other.

Said product having a framework or a support consisting of a fibrous material, at least one surface part being covered, when necessary, by a layer creating a barrier, such as a foil or film resistant to gas or moisture, e.g. a plastic foil or film, and said mould parts, when fully united, exposing an inner cavity, with defining outer and inner surfaces partially or entirely following the shape of a produced product or an object.

The successive steps related to the known method are:
a) that an elongate foil or film, with a layer of a compressive material, formed to a fluffy material structure, as a portion resting thereon, is allowed to be introduced between opened mould parts,
b) that the mould parts are to be united or moved towards each other to enclose a foil or film portion and a corresponding fluffy material portion and press a fluffy material structure as a “string”, surrounding said foil or film portion against and along a defining line or area, corresponding to an edge oriented defining line or area for the product or the object,
c) that said foil or film portion, with a fluffy material structure portion applied and supported thereon, and surrounded by said mould parts, is caused to be displaced towards and into a cavity, formed within one of the used mould parts (female part) having an inner shape corresponding partially or completely to the outer shape of the product or object in order, by means of a means influencing the foil or film portion, to pressing said fluffy material structure portion into and against the inner surface of the female exposing mould part, and
d) that the mould parts, the female part and the foil or film part, are thereafter conveyed or moved towards their open initial position, for exposure of a compressed non-deformable product or non-deformable products or objects.

Especially it is disclosed that said means, in accordance with step “c”, consists of an elastic foil or film portion, influenced by air or gas under a positive pressure, for pressing the fluff material structure into and towards an inner wall section related to said female part.

Considering the objects related to the present invention it is also to be mentioned different methods for the production of one or more of a plurality of different thin-walled products or objects, such as packaging objects, intended to enclose one or several items, in which the material of the objects may be aluminium, plastic and/or fibre material.

Since the present invention is based primarily on the production of packaging products or objects of disposable types, and makes use of a fibrous material structure as a starting and frame or support material, only this application will be considered in detail.

Thus, various methods are already known for producing packaging products or objects of different shapes from a fibrous material, such as wood fibre.

The method chosen for this depends on the choice of starting material, desired production speed, desired structure and shape of the end product or object, as well as other criteria.

One such previously known method for producing products from a wood fibrous pulp material is based on a technique that may be termed “pulp moulding” and is based on a “wet” method.

In an established method this “pulp moulding” is performed by using a stock or grist, a wood fibrous material or similar material, dissolved in water, together with selected additives, such as adhesive, etc., through a forming tool, having a shape complementary to the outer shape of the product or object, the wood fibrous material adhering to the surface of the tool, while the pulp dissolving water passes through perforations in the forming tool.

It is here usual for the wood fibrous concentration to be as low as 0.5-1%, which means that 200 to 100 times as much water must be handled.

Furthermore, in this known technology, forming tools must be made of a stainless material.

The forming tool must also be provided with uniformly distributed perforations in the form of small holes for the passage of said pulp water. Experience has shown that, for satisfactory function, these holes must be tightly drilled and well distributed, with a diameter of around 1 to 2 mm.

Furthermore, the use of such forming tools requires a complementary surface facing the product to be covered with a wire net or cloth and this, too, must be of stainless material.

It is known that the drilling of all these small holes, as well as shaping and applying a wire net or cloth structure, require qualified, expensive manual labour.

Such a tool must withstand water, fibres, chemicals, vacuum and at least a certain amount of pressure.

The wire net or cloth must also be so strongly dimensioned that the product or object produced, in the form of a fibrous “cake”, can be released from the net or cloth.

The need for cleaning the wire net or cloth structure, etc., as well as the rest of the forming tool, is thus considerable.

After this type of moulding, a semi-manufacture must be transferred, or wet-pressed and transferred to a drier, or after-pressing and/or drying must be performed immediately between hot tool halves.

Such tool halves, necessary for a subsequent treatment, must also be made of a stainless material, be drilled with small holes and otherwise be shaped to give the product or object its final shape.

It is also known that during the time sequence the semi-manufacture product dries its dimensions also reduce or shrink, which generally requires that the tool, used for a sub-sequent treatment, is to be adapted or suited to the relevant dimensions.

The drying sequence used in this method is expensive and requires a considerable amount of energy.

The content of patent publication U.S. Pat. No. 4,337,116 also belongs to the prior art and shows a fibre-cast or pulp mould packaging product, consisting of wood fibre material and provided with a polyester layer.

The prior art may also be supplemented by the content of the patent publication number WO-A1-97/19803, showing and describing how a woven textile material can be compressed to a three-dimensional shape, with the aid of a thermoplastic with a hollow shape, where a layer of adhesive is used to hold the thermoplastic layer together with the textile material.

### CONSIDERATION OF THE PRESENT INVENTION

### Technical Problems

Considering the circumstance that the technical deliberations that must be made by a person skilled in the art to be able to offer a solution to one or more technical problems posed is, on the one hand, initially a necessary insight into the measures and/or sequence of measures to be adopted and, on the other hand, a necessary selection of the means required, the following technical problems are likely, in view hereof, to be relevant in the evolution and development of the subject matter related to the present invention.

Considering the state of the art, as described above, it should therefore be seen as a technical problem to be able to realise, in a method and an arrangement, adapted for producing one or several products or one or several objects, by means of a compression moulding procedure, using at least two mould parts, one female part and one male part, arranged movably towards and away from each other, whereby said mould parts, in a fully united and interacting position, is exposing an inner cavity, with defining surfaces or wall sections, following the shape of said product or said object, whereby;
a) a layer of a fluffy material structure is to be introduced between opened mould parts,
b) said mould parts are thereafter moved towards each other to enclose a section of said fluffy material structure and a chosen glue liquid content,
c) said fluffy material structure and said glue liquid content are displaced towards and into said cavity, in order to compressing said fluffy material structure portion and a glue liquid content into a compressed cellulose material structure by a male part related wall section, against an inner surface or wall section of said female part, and
d) the mould parts are moved towards and into an open position, to expose and extract said product or said object,
   the importance of, the advantages associated with and/or the technical measures and considerations which will be required in order to have said mould parts to move to said fully united position and exposing said cavity, whereby the volume of said cavity is chosen smaller than said compressed cellulose material structure and said chosen glue liquid content, and that said glue liquid content is chosen sufficient for, under said pressure from said mould parts, fully moistening said compressed cellulose material structure.

There resides a technical problem in being able to realise the importance of, the advantages associated with and/or the technical measures and considerations which will be required in order to, in an after-treatment step, having one or more products subject to a finishing treatment, for forming the outer and/or the inner shape of the product, towards a form of an object.

There resides a technical problem in being able to realise the importance of, the advantages associated with and/or the technical measures and considerations which will be required in order to have said glue liquid content and said compressible fluff material structure distributed as a pre-mixture or layers over a flexible carrier material supported by a male part.

There resides a technical problem in being able to realise the importance of, the advantages associated with and/or the technical measures and considerations which will be required in order to forming a semi-manufacture of said product, moistened to a “saturation” stage, and placing said semi-manufacture product in a subsequent after-treatment equipment for drying and/or setting said glue liquid content for forming a solid product or object.

There resides a technical problem in being able to realise the importance of, the advantages associated with and/or the technical measures and considerations which will be required in order to have a utilised glue liquid content being selected from a liquid having a viscosity of less than 500 mPas, such as from 50 to 200 mPas.

There resides a technical problem in being able to realise the importance of, the advantages associated with and/or the technical measures and considerations which will be required in order to have said male part adapted to be displaced upwardly, in order to lift a flexible carrier section with associated fluff material structure and its glue liquid content, enclosed between said mould parts, into and towards a female part, located above said flexible carrier section.

There resides a technical problem in being able to realise the importance of, the advantages associated with and/or the technical measures and considerations which will be required in order to have said male part adapted to be displaced downwardly, in order to urge a fluff material structure and its glue liquid content, enclosed between mould parts, and a flexible carrier section downwards towards and into a female part, located beneath said carrier section.

There resides a technical problem in being able to realise the importance of, the advantages associated with and/or the technical measures and considerations which will be required in order to have a semi-manufacture product and/or a dried semi-manufactured product finally formed as a completed or final object, by one or more subsequently oriented steps, such as an compression and/or punching stations.

There resides a technical problem in being able to realise the importance of, the advantages associated with and/or the technical measures and considerations which will be required in order to have resin, water glass, starch or the like, wholly or partly selected as said glue liquid content, for all materials serving as an adhesive material adapted to a used cellulose fluff structure.

There resides a technical problem in being able to realise the importance of, the advantages associated with and/or the technical measures and considerations which will be required in order to have an adhesive material, exposing a high total solid content, being selected as said glue liquid content.

There resides a technical problem in being able to realise the importance of, the advantages associated with and/or the technical measures and considerations which will be required in order to have, in a subsequent after-treatment process step, a plastic film, different or separated from any carrier material, being secured to one side of a dried and ready-treated semi-manufacture product, in order to form a solid object.

There resides a technical problem in being able to realise the importance of, the advantages associated with and/or the technical measures and considerations which will be required in order to have a subsequent additional plastic film and said carrier section of said carrier material secured, by means of a heating process of said semi-manufacture product, during a compression force, acting against an inner portion of said semi-manufacture product, takes place by using an excess air pressure arrangement.

There resides a technical problem in being able to realise the importance of, the advantages associated with and/or the technical measures and considerations which will be required in order to have said fluff material structure being selected from a material consisting of a pure cellulose fluff structure and/or a mixture of one or more cellulose fluff materials and a selected filler material, and as said filler material is selected materials as chalk, synthetic fibre material or the like.

There resides a technical problem in being able to realise the importance of, the advantages associated with and/or the technical measures and considerations which will be required in order to have said fluff material structure layered with interjacent oriented glue liquid content layers and/or product and object reinforcing layers.

There resides a technical problem in being able to realise the importance of, the advantages associated with and/or the technical measures and considerations which will be required in order to have an equipment, adapted for drying and/or setting said compressed cellulose material structure mixed with said glue liquid content, consisting of a unit based on microwave heating.

### Solution

The present invention thus takes as its starting point the state of the art as disclosed by way of introduction where a method and an arrangement for producing one or several products or one or several objects, by means of a compression moulding procedure, are using at least two mould parts, one female part and one male part, arranged movably towards and away from each other, whereby said mould parts, in a fully united and interacting position, is exposing an inner “cavity”, with defining surfaces or wall sections, following the shape of said product or said object, whereby;
a) a layer of a fluffy material structure is to be introduced between opened mould parts,
b) said mould parts are thereafter moved towards each other to enclose a section of said fluffy material structure and a chosen glue liquid content,
c) said fluffy material structure and said glue liquid content are displaced towards and into said cavity, in order to pressing said fluffy material structure portion and a glue liquid content, into a compressed cellulose material structure by a male part related wall section, against an inner surface or wall section of said female part, and
d) the mould parts are moved back towards and into an open position, to expose and extract said product or said object.

In order to be able to solve one or more of the above-outlined technical problems, the present invention particularly proposes that the prior art is to be supplemented by the following steps; when said mould parts are moved to said fully united position and exposing said “cavity”, the volume of said cavity is chosen somewhat smaller than the volume of said compressed cellulose material structure and its chosen glue liquid content, and that said glue liquid content is chosen sufficient for, under pressure from said mould parts, fully moistening said compressed cellulose material structure.

As preferred embodiments, falling within the scope of the basic inventive concept of the present invention, there is in addition proposed that said one or more products are subject to a further or after-treatment, for forming the outer and/or the inner shape of the product, towards a form representing an object.

It is also suggested that said glue liquid content and said compressible fluff material structure are distributed as layers over a flexible carrier material.

It is also suggested that a forming of a semi-manufacture as said product, moistened to a “saturation” stage, and treating said semi-manufacture product in a subsequent after-treatment equipment for drying and/or setting said glue liquid content, is caused for forming a solid product or a solid object.

It is also suggested that a utilised glue liquid content is selected to have a viscosity of less than 500 mPas, such as a viscosity of 50 to 200 mPas.

It is also suggested that said male part is adapted to be displaced upwardly, in order to lift a flexible carrier section with associated moistened fluff material structure, enclosed between said mould parts, into and towards a female part, located above said carrier section.

The present invention also discloses that said male part is adapted to be displaced downwardly, in order to urge a fluff material structure, a glue liquid content, enclosed between mould parts, and a flexible carrier section downwards towards and into a female part, located beneath said carrier section.

The present invention also discloses that a semi-manufacture product and/or a dried semi-manufactured product is finally formed, as a completed object, by intermediary one or more subsequently oriented compression and/or punching stations.

The present invention also discloses that resin, water glass, starch or the like is wholly or partly selected as said glue liquid content, for all materials serving as an adhesive material adapted to a used cellulose fluff structure.

Moreover, it is suggested that, in a subsequent process step, a plastic film, in addition to or separated from said carrier material, is secured to one side of a dried, such as ready-treated semi-manufacture, in order to form a solid product or object.

Moreover, it is suggested that a subsequent additional plastic film and a carrier section of said carrier material are secured, by means of heating process of said semi-manufacture, and where a compression force, against an inner portion of said semi-manufacture, takes place at an excess air pressure arrangement.

It is also proposed that said fluff material structure being selected from a material consisting of a pure cellulose fluff structure and/or a mixture of one or more cellulose fluff materials and a selected filler material, and that as a filler material is selected chalk, synthetic fibre material or the like.

It also proposed that said fluff material structure is layered with interjacent oriented glue liquid content layers and/or reinforcing layers.

Further it is suggested and proposed that an equipment, adapted for drying and/or setting said glue liquid content, consists of a unit based on microwave heating.

### ADVANTAGES

The advantages which may principally be considered as characterising the present invention and the significative characterising features associated with the present invention are that prerequisites have hereby been created for moving said mould parts to a fully united position and exposing a “cavity”, the volume of said cavity is chosen smaller than the volume of a compressed cellulose material structure and the volume of a chosen glue liquid content, and that said glue liquid content is chosen sufficient for, under pressure from said mould parts, fully moistening said compressed cellulose material structure. Said glue liquid content is chosen more or less in excess, so that a small glue liquid content may come oozing out from said cavity, at said fully united position.

That which may principally be deemed as characterising for a method according to the present invention is disclosed in the characterising clause of appended claim 1 and an arrangement is disclosed in the characterising clause of appended claim 16.

### BRIEF DESCRIPTION OF THE ACCOMPANYING DRAWINGS

Currently proposed embodiments, displaying the significative characterising features associated with a method and an arrangement, related to the present invention, will now be described in greater detail hereinbelow for purposes of exemplification and with reference to the accompanying Drawings. In the accompanying Drawings:

FIG. 1 is showing in blocks an arrangement and a method according to the present invention,

FIGS. 2A and 2B show a first and a second alternative of a fluffy material structure and a glue liquid content, applied in two layers, and where FIG. 2B illustrates the use of a support film,

FIG. 3 is showing a further alternative of a fluffy material structure and a given liquid content applied in additional layers,

FIG. 4 is a side view of two mould parts in an opened position,

FIG. 5 is a side view of two mould parts in an opened position, having the fluffy material structure and the glue liquid content fully premixed and supported by a flexible carrier material, and

FIG. 6 is a side view where the two mould parts, as shown in FIG. 5, is almost in a fully united and interacting position.

FIG. 7 illustrates in three sequences, under “A”, “B” and “C” a production of an object from a given glue-fluffy material mixture compressed by using a female and a male part.

### DESCRIPTION OF CURRENTLY PROPOSED EMBODIMENT

It should be emphasized by way of introduction that, in the following description of currently proposed embodiments which display the significative characterising features relating to the present invention and which are clarified by means of the Figures, shown in the accompanying Drawings, we have selected terms and special terminology with the intention principally of clarifying the inventive concept.

However, in this context it should be observed that the expressions selected here should not be considered as restrictive exclusively to the terms selected and utilised here but it should be understood that each thus selected term is to be interpreted so that, in addition, it encompasses all technical equivalents which function in the same or substantially the same manner in order thereby to be able to attain the same or substantially the same intention and/or technical effect.

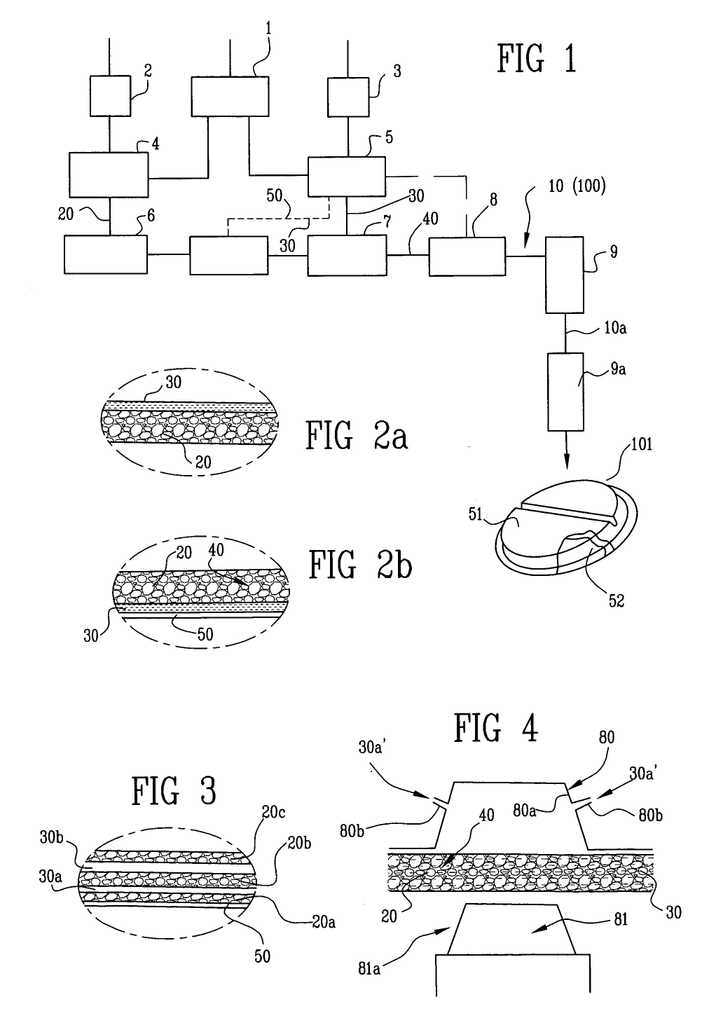

With reference to the accompanying Drawings and the FIGS. 1 to 6, the basic preconditions for a method and an arrangement of the present invention are thus shown schematically and in detail and where the significative properties associated with the invention have been rendered in concrete form, as a result of the now proposed embodiments described in greater detail hereinbelow.

Thus in FIG. 1 the different blocks are intended to identify different means, apparatuses and functions, all related to the inventive method and its arrangement.

In FIG. 1 reference numeral 1 indicates a control unit; reference numeral 2 a fluffy material structure feeding equipment; reference numeral 3 a glue liquid content feeding equipment; reference numeral 4 a fluffy material structure dosage apparatus; and reference numeral 5 a glue liquid content dosage apparatus.

An arrangement 6 is illustrated for spreading said fluffy material structure 20 with a pre-determined thickness and an arrangement 7 is illustrated for spreading said glue liquid material or content 30 over said fluffy material structure 20, as illustrated in FIG. 2A.

In FIG. 2B the fluffy material structure 20 is supported by a layer 30 of a glue liquid content. Said glue liquid content 30 is directly supported by an elastic film 50.

A mixture 40, shown in FIG. 2A or 2B is compressed according to the present invention in a compression moulding procedure, indicated by reference numeral 8 in FIG. 1 for the production of a product 10 or an object (100), alternatively a number of products 10 or a number of objects (100).

These products 10 may be seen as semi-materials and adapted for an after-treatment in a further compression moulding procedure or step 9, for compressing the shape of the product 10 into a second product 10a and drying said product 10a.

A further after-treatment procedure or step 9a is used for covering the product 10 or 10a with an elastic film or foil, for the production of a water resistant object 100, here illustrated as a plate.

The fluffy material structure 20 and the glue liquid content 30 may as an alternative be as a mixture 40.

FIG. 3 discloses an alternative, in which a flexible carrier material 50 is directly supporting a first thin fluffy material structure 20a, a first thin glue liquid material 30a, a second thin fluffy material structure 20b, a second thin glue liquid material 30b and a third thin fluffy material structure 20c.

It is obvious that different layers may be used and it is also possible to inject the glue liquid material 30 directly into the compression chamber of the compression moulding procedure 8 during or prior to a final compression.

Thus, FIG. 1 shows a method and an arrangement for the production of one or several products 10 or one or several objects 100, by means of a compression moulding procedure 8, using at least two mould parts, one female part 80 and one male part 81, arranged movably towards and away from each other, whereby said mould parts, in a fully united and interacting position (essentially illustrated in FIG. 6), is exposing an inner “cavity”, with defining surfaces or wall sections, following the shape of said product 10 or said object 100.

In FIG. 4 the inner surface or wall section, in the form of a frustum of a cone, 80a and the outer surface or wall section 81a are exposing matching surfaces for forming said product 10.

The method and the arrangement disclose that;
a) a layer 20 of a fluffy material structure with a glue liquid content 30 or a mixture 40 is to be introduced between opened mould parts 80, 81, as shown in FIG. 4,
b) said mould parts 80, 81 are by not shown means caused to be moved towards each other, to a position disclosed in FIG. 6, to enclose said fluffy material structure 20 and a chosen glue liquid content 30, here pressure mixed,
c) said fluffy material structure 20 and said glue liquid content 30 are displaced towards and into said cavity 70, in order to pressing said fluffy material structure portion 20 into a compressed cellulose material structure 20′ with said glue liquid content 30, by a male part 81 related wall section 81a, against an inner surface or wall section 80a of said female part 80, and

d) the mould parts 80, 81 are thereafter moved towards an open position, to expose and extract said product 10 or said object 100.

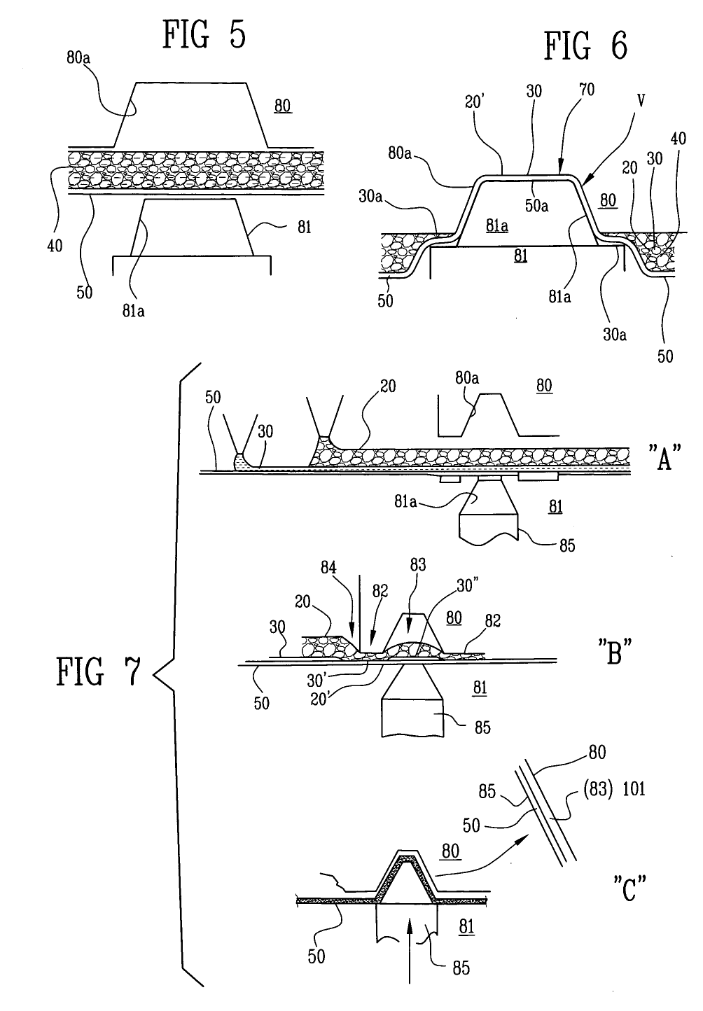

FIG. 5 illustrates that the fluffy material structure and the glue liquid content are premixed 40 and supported by a film 50.

The present invention discloses especially that when said mould parts 80, 81 are moved to said fully united position and exposing said cavity 70, the volume “V” of said cavity 70 is chosen smaller than the volume of said compressed cellulose material structure 20′ and said chosen glue liquid content 30, and that the volume of said glue liquid content 30 is chosen sufficient for, under the pressure from said mould parts 80, 81, fully moistening said compressed cellulose material structure 20′.

The expression “fully moistening” is meant that the chosen volume of glue liquid content 30, controlled by said control unit 1, is sufficient for filling all pores, or essentially all pores, within the porosities of the fluffy material in its compressed form 20′, so that the outer and the inner surfaces of said product 10 are intact.

Said product 10 may be subject to a further treatment 9, 9a, for forming the outer and/or the inner shape of the product 10, 10a, towards a final form of an object 100.

The present invention discloses that said glue liquid content 30 is chosen in excess, so that a small glue liquid content 30a may be coming oozing out from said cavity 70, at said fully united position.

Excess glue liquid content 30a′ may also be oozing out through holes 80b in the wall section 80a, as illustrated in FIG. 4.

Said glue liquid content 30 and said compressible fluff material structure 20 may be distributed as one or more thicker or thinner layers over a flexible carrier material 50.

Forming any semi-manufacture of said product 10 or said object 100, moistened to a “saturation” stage, may be caused by placing said semi-manufacture product 10 or object in a subsequent equipment (not shown) for drying and/or setting said glue liquid content for forming a solid product 10a or object.

More precisely, a utilised glue liquid content 30 is selected via said control unit 1 to have a viscosity of less than 500 mPas, such as between 50 and 200 mPas.

More precisely, said viscosity is selected to be between 100 and 150 mPas.

A viscous glue particle substrate of a high viscosity may be diluted, using an additive in order to, in a mixed state, display said viscosity.

Said diluent solution of said additives is of low viscosity, such as water and the like.

Moreover, a glue liquid content 30, enclosed between mould parts 80, 81, may be injected into a fluffy material structure and/or premixed therewith, as indicated by a dotted line 5a in FIG. 1.

Said male part 81 is in the FIG. 6 embodiment adapted to be displaced upwardly, in order to lift a flexible carrier section 50a with associated moistened fluff material structure, enclosed between said mould parts 80, 81, into and towards a female part 80, located above said carrier section 50a.

Another embodiment, not shown, however obvious, discloses that said male part 81 is adapted to be displaced downwardly, in order to urge a fluffy material structure 20, a glue liquid content 30 or a mixture 40 thereof, enclosed between said mould parts 80, 81, and a flexible carrier section 50a downwards, towards and into a female part, located beneath said carrier section.

A moistened semi-manufacture 10 may be a product treated via prior compression moulding in one or more compression moulding steps (not shown), before said semi-manufacture product 10 is processed in a drying and/or setting equipment 9.

A compression moulding procedure, in one or more additional compression moulding procedure steps 9, takes place by one or more moulding parts distributed between said compression moulding procedure 8 and a drying and/or setting step 9, forming said semi-manufacture product towards an object 100.

A semi-manufacture product and/or a dried semi-manufactured product 10a is finally formed, as a completed object 100, by an intermediary one or more subsequently oriented compression and/or punching stations.

FIG. 1 discloses that a tray or a plate configuration 101 is imparted to said semi-manufacture and/or said object.

Resin, water glass, starch or the like is wholly or partly selected as said glue liquid content 30, for all materials serving as an adhesive material adapted to a used cellulose fluff structure 20.

It is also suggested that an adhesive or glue material, having a high total solid content, is selected as said glue liquid content 30.

The glue liquid content, its volume as well as a chosen fluffy material structure are adapted to expose the desired size, thickness and/or stiffness of the product 10 or object 100.

The FIG. 1 embodiment also discloses that, in a subsequent process step 9a, a very thin plastic film 51, in addition to said carrier material 50, is secured to one side of a dried and ready-treated semi-manufacture 10a, in order to form a solid product or object 101.

A subsequent additional plastic film 52 and a carrier section of said carrier material 50 are secured, by means of a heating process 9a of said semi-manufacture 10a, and where a required compression force, against an inner portion of said semi-manufacture, takes place at an excess air pressure arrangement.

During said compression step 8 forming a semi-manufacture product 10, the glue liquid content in excess 30a is distributed to and saturating said fluffy material structure 20′ so that any occurring porosities, free of fluffy material, are filled out with said adhesive glue liquid content 30.

Said elastic films 50, 51 and 52 being selected from a plastic material, for example a polyester, a bio film, a thermoplastic film or other similar material.

Said fluffy material structure 20 being selected from a material consisting of a pure cellulose fluffy structure and/or a mixture of one or more cellulose fluffy materials and a selected filler material, such as a selected chalk, synthetic fibre material or the like.

It is also suggested that said fluffy material structure 20 and the glue liquid content 30 are distributed as a first layer of a pure or admixed fluffy material structure and a second layer of a glue liquid content, placed and distributed over said first layer.

Said fluffy material structure and the glue liquid content are distributed as a single layer of a pure or admixed fluffy material structure, admixed with a glue adhesive or liquid content quantity.

Said fluffy material structure and the glue liquid content are distributed as a single layer of a pure or admixed fluffy material structure and a layer of a glue liquid content, placed and distributed under said fluffy material structure.

More precisely, said fluffy material structure is layered with interjacent oriented glue liquid content layers and/or reinforcing layers.

A semi-manufacture product is displaying a structure and is given a stiffness adapted so as to be able to be intact, when displacing a number of laterally oriented semi-manufacture products where all are carried and supported by said carrier to an adjacent drying and/or setting equipment 9, 9a.

After a processing step, for forming a number of laterally related soft semi-manufacture products 10 with the aid of an elastic or flexible carrier 50, there are additional forming steps for the produced semi-manufacture products 10 towards a finished object 100.

Said additional forming steps towards a finished object 100 consists of causing, by means of object-supplied heat, a plastic film and/or other selected surface coatings to melt and/or fuse.

Said plastic film and/or said additional surface coating is fixable, in order to form a finished product and/or a finished object 100, via an applied excess air pressure, which urges the film and/or the surface coating against the product, and where said film or surface coating is adapted, by object-supplied heat and said applied excess pressure, to more or less melt and fuse against the inner surface of the product or the object 100.

An equipment 9a, adapted for drying and/or setting said glue liquid content, consists of a unit based on microwave heating.

One or more of said compression moulding stations are adapted to cause, by using compressed air, said moistened semi-manufacture product to be additionally formed by using an elastic membrane, which is urged into said female part 80.

One or more of said subsequent compression stations are adapted to cause, by using compressed air, the dry semi-manufacture to be covered by an elastic membrane or film which is urged into a heated object via the female part.

FIG. 7 is intended to illustrate in three different sequences, “A”, “B” and “C”, a production line for the production of one (or more) objects 101 from a glue-fluff-material mixture, said mixture is compressed between an upper female part 80 and a lower male part 81, with a piston part 85 of a compression equipment.

Sequence “A” illustrates that a layer of a liquid glue material 30 is spread over and supported by an elastic plastic film 50.

Over said glue material 30 is spread a fluffy material 20 and the content of said glue material 30 and the content of said fluffy material 20 are adapted in accordance with the principles related to the present invention and discussed previously.

The glue material 30 and the fluffy material 20 are transported to the right in FIG. 7 and between opened parts 80 and 81, and by said plastic film 50 or other similar means.

In a sequence “B” said female part 80 is moved towards said male part 81 and is thereby causing a pre-compressed zone 82 of said glue material 30′ and said fluffy material 20′, in which zone 82, said materials 30′ and 20′ are more or less totally mixed.

In zones 83, 84, adjacent said pre-compressed zone 82, no compression at all or very small compression is at hand by said movement.

This pre-compression zone 82 may further expose criteria allowing a small amount of glue material 30″ in excess from zone 83 to fully or partly pass through said zone 82.

Sequence “C” illustrates that said piston part 85 has been moved upwardly and into the female part 80 under a compression of the zone 83 to form said object 101.

Excess glue material 30″ may also be caused to pass through holes in part 80 (see FIG. 4) in a final compression sequence towards forming said object 101.

The present invention is naturally not restricted to the embodiment disclosed by way of example above but may be subject to modifications without departing from the inventive concept, as disclosed in the appended Claims.

In particular, it should be observed that each illustrated unit and/or circuit may be combined with every other shown unit and/or circuit without departing from the scope of the invention in order to be able to attain the desired technical function.

1-29. (canceled)

30. A method for producing one product by means of a compression molding procedure (8) using at least two mould parts, one female part (80) and one male part (81), arranged movable towards and away from each other, whereby when said mould parts are in a closed position, an inner cavity (70) is exposed, with wall sections (80a, 81a) following the shape of said product (10), whereby
a) a layer of a fluffy material structure (20) is introduced between opened mould parts (80, 81) together with a chosen glue liquid content (30),
b) said mould parts (80, 81) are moved towards each other to enclose both said fluffy material structure (20) and said chosen glue liquid content (30),
c) said fluffy material structure (20) and said glue liquid content (30) are constrained into said cavity (70) in order to pressing said fluffy material structure portion into a compressed cellulose material structure (20′) and said glue liquid content (30), by a male part (81) related wall section (81a) against a wall section (80a) of said female part (80), and
d) the mould parts (80, 81) are moved towards an open position, to expose and extract said product (10),
wherein when said mould parts (80, 81) are moved to said fully united position and expose said cavity (70), the volume of said cavity (71) is chosen smaller than the volume of said compressed cellulose material structure (20′) and the volume of said chosen glue liquid content (30) before compression, and that said glue liquid content (30) is chosen sufficient for, under pressure from said mould parts (80, 81), fully moistening said compressed cellulose material structure (20′).

31. A method according to claim 30, wherein said one product is subject to a further treatment (9, 9a) for forming the outer and/or the inner shape of the product, for obtaining a form of an object (100).

32. A method according to claim 30 wherein said glue liquid content and said compressible fluff material structure are distributed as layers over a flexible carrier material.

33. A method according to claim 30 comprising the further step of forming a semi-finished product, moistened to a “saturation’ stage, and placing said semi-finished product (10) in a subsequent equipment (9, 9a) for drying and/or setting said glue liquid content for forming a solid product.

34. A method as claimed in claim 30, wherein a glue liquid content is selected to have a viscosity of less than 500 mPas, such as between 50 and 200 mPas.

35. A method as claimed in claim 30 wherein said male part is adapted to be displaced upwardly, in order to lift a flexible carrier section with associated moistened fluff material structure, enclosed between said mould parts, into and towards a female part, located above said carrier section.

36. A method as claimed in claim 30 wherein said male part is adapted to be displaced downwardly, in order to urge a fluff material structure and a glue liquid content, enclosed between mould parts, and a flexible carrier section downwards and towards and into a female part, located beneath said carrier section.

37. A method as claimed in claim 30 wherein a semi-finished product and/or a dried semi-finished product is finally formed, as a completed object, by an intermediary one or more subsequently oriented compression and/or punching stations.

38. A method as claimed in claim 30 wherein resin, water glass or starch are selected as said glue liquid content, for all materials serving as an adhesive material, adapted to a used cellulose fluff structure.

39. A method as claimed in claim 30, wherein in a subsequent process step, a plastic film, in addition to said carrier material, is secured to one side of a dried and ready-treated semi-finished product, in order to form a solid product.

40. A method as claimed in claim 39, wherein a subsequent additional plastic film and a carrier section of said carrier material are secured, by means of heating process to said semi-finished product, and where a compression force, against an inner portion of said semi-finished product takes place at an excess air pressure arrangement.

41. A method as claimed in claim 30 wherein said fluff material structure is selected from a material consisting of a pure cellulose fluff structure and/or a mixture of one or more cellulose fluff materials and/or a selected filler material, and as such a filler material is selected from chalk, synthetic fibre material or the like.

42. A method as claimed in claim 30 wherein said fluff material structure is layered with interposed oriented glue liquid content layers and/or reinforcing layers.

43. A method as claimed in claim 30 wherein an equipment, adapted for drying and/or setting said glue liquid content, consists of a unit based on microwave heating.

44. A method according to claim 30, wherein said glue liquid content is chosen in excess, so that a small glue liquid content (30a) may come oozing out from cavity (70) when said mould parts are in the closed position.

45. A method according to claim 44, wherein an excess glue liquid content (30a′) oozes out through holes (80b) in the wall section (80a) of the mould parts.

46. A method according to claim 30, wherein the chosen volume of the glue liquid content is chosen sufficient for essentially filling all pores within the porosity of the fluffy material in its compressed form (20′), so that outer and inner surfaces of said product are smooth and intact.

47. A method for producing one product by means of a compression molding procedure (8) using at least two mould parts, one female part (80) and one male part (81), arranged movable towards and away from each other, whereby, when said mould parts are in a closed position, an inner cavity (70) is defined having wall sections (80a, 81a) counter-shaped to the shape of said product (10) whereby
a) a layer of a cellulosic fluffy material structure (20) together with a chosen glue liquid content (30) is introduced between opened mould parts (80, 81),
b) said mould parts (80, 81) are moved towards each other to enclose both said fluffy material structure (20) and said chosen glue liquid content (30),
c) said fluffy material structure (20) and said glue liquid content (30) are constrained into said cavity (70) in order to pressing said cellulosic fluffy material structure into a compressed cellulose material structure (20′) and pressing said glue liquid content (30), constraining compressed cellulose material structure (20′) and pressing said glue liquid content (30) between the male part (81) wall section (81a) and the female part (80) wall section (80a), and
d) the mould parts (80, 81) are moved towards an open position to expose and extract said product (10),
wherein when said mould parts (80, 81) are moved to said closed position and expose said cavity (70), the volume of said cavity (71) is chosen smaller than the volume of said compressed cellulose material structure (20′) and the volume of said chosen glue liquid content (30) before compression, and that said glue liquid content (30) is chosen sufficient for, under pressure from said mould parts (80, 81), fully moistening said compressed cellulose material structure (20′), said glue liquid content being chosen in excess, so that a small glue liquid content (30a) may come oozing out from cavity (70) when said mould parts are in the closed position and the chosen volume of the glue liquid content is chosen sufficient for essentially filling all pores within a porosity of the fluffy material in its compressed form, so that after extraction from the moulds outer and inner surfaces of said product are smooth and intact.
